(19) United States
(12) Patent Application Publication
(10) Pub. No.: US 2012/0328779 A1
(43) Pub. Date: Dec. 27, 2012

(54) STRUCTURE MADE OF GETTER MATERIAL HERMETICALLY PROTECTED DURING MANUFACTURING

(75) Inventors: Stéphane Caplet, Shilin District (TW); Xavier Baillin, Crolles (FR)

(73) Assignee: Commissariat A L'Energie Atomique Et Aux Ene Alt, Paris (FR)

(21) Appl. No.: 13/530,513

(22) Filed: Jun. 22, 2012

(30) Foreign Application Priority Data
Jun. 23, 2011 (FR) 11 55564

(51) Int. Cl. B05D 5/00

(52) U.S. Cl. 427/245

(57) ABSTRACT

Process for making a device comprising at least the following steps:
produce a getter structure comprising at least one portion of getter material permeable to gas covered by at least one protective layer hermetic to gas;
hermetic encapsulation of the getter structure in a cavity;
production of at least one local opening passing through the protective layer and forming an access to the portion of getter material permeable to gas.

### TECHNICAL FIELD

The invention relates to the field of getter structures, in other words structures comprising one or several getter materials capable of gas absorption and/or adsorption in a closed environment.

In particular, such a structure may be used in the field of microcomponents such as Micro ElectroMechanical Systems (MEMS) or Nano ElectroMechanical Systems (NEMS), for example accelerometers, gyrometers or any other device for example intended to be encapsulated in an environment under a deep vacuum, under controlled pressure or under protective atmosphere.

### STATE OF PRIOR ART

A getter material is a material with gas absorption and/or adsorption properties, either intrinsically and/or through its microscopic morphology. Such a getter material can thus form a chemical gas pump when it is placed in a closed environment. This type of material can also be used in many microelectronic applications such as vacuum tubes, field effect systems or with microcomponents such as MEMS or NEMS for example to make an environment under a deep vacuum or under controlled pressure. In the case of encapsulated MEMS or NEMS, an environment under a deep vacuum formed around the device can for example be used to obtain better functioning of resonant mechanical systems but also optical systems sensitive to the absorption of light radiation by gas surrounding the device.

Non-evaporable getter (NEG) materials are for example metals such as titanium, zirconium, hafnium or binary metallic alloys of these three metals. A non-evaporable getter material is usually deposited directly on a wall of the enclosure in which a chemical pump is to be made in the form of a thin layer. This material is then thermally activated by heating it through the wall of the enclosure on which it is deposited.

Document U.S. Pat. No. 6,923,625 B2 discloses the production of such a thin layer of getter material.

After the getter material has been formed, it will be protected by a thin protective layer for example composed of metal, to prevent contamination or oxidation of the getter material and also make it impossible for the getter material to do any gas absorption before it is encapsulated. The protective layer is then eliminated to expose the getter material to surrounding gas.

Document FR 2 883 099 discloses production of a getter material protected by a protective layer and used for encapsulation of a microcomponent. Once the microcomponent has been encapsulated and the getter material has been made, the protective layer is consumed so as to expose the getter material to the atmosphere in the cavity.

In these two documents, the protective layer of the getter material is eliminated by means of a heat treatment that causes diffusion or creep of the protective layer, thus exposing the getter material in the cavity. This heat treatment may be prejudicial or even incompatible with the remainder of the encapsulated structure considering the thermal budgets involved.

### PRESENTATION OF THE INVENTION

Thus there is a need to propose a new getter structure that can be used for gas absorption and/or adsorption, for example in a hermetically closed cavity in which the getter material is hermetically protected during production and does not require the use of a heat treatment to expose the getter material to surrounding gas.

Thus, it is proposed a getter structure comprising at least one portion of getter material permeable to gas covered by at least one protective layer hermetic to gas, in which at least one local opening passes through the protective layer and forms an access to the portion of getter material permeable to gas.

One embodiment of the invention discloses a process for making a device comprising at least the following steps:
produce a getter structure comprising at least one portion of getter material permeable to gas covered by at least one protective layer hermetic to gas;
hermetic encapsulation of the getter structure in a cavity;
production of at least one local opening passing through the protective layer and forming an access to the portion of getter material permeable to gas.

Thus, in making a local opening through the protective layer, in other words an opening made through only part of the hermetic protective layer and such that one or several remaining portions of the hermetic protective layer covers the portion of getter material permeable to gas, there is no need to totally eliminate the protective layer hermetic to gas when the getter structure is encapsulated. Furthermore, such a local opening may be made without applying a heat treatment that could damage the remainder of the structure.

“Permeability” of a portion of material refers to its ability to enable gas to circulate in said portion of material, in at least one direction parallel to a principal plane of the portion and also in a direction perpendicular to this plane. The portion of getter material in this case is permeable to gas, in other words gas can circulate laterally and vertically through this portion.

The portion of getter material permeable to gas may be placed in contact with a support, portions of the protective layer may also rest on the support. In this case the portion of getter material permeable to gas is encapsulated between the support and the protective layer.

A first part of the protective layer may be placed in contact with a support, the portion of getter material permeable to gas possibly being placed above or on this first part of the protective layer, a second part of the protective layer possibly covering the portion of getter material permeable to gas and being supported on the first part of the protective layer. In this case, the portion of getter material permeable to gas is entirely encapsulated by the protective layer.

The assembly formed by the portion of getter material permeable to gas and the protective layer that encapsulates the getter material may be formed directly on the support or it may be added onto the support after having been made.

The portion of getter material permeable to gas may be placed in contact with at least one another portion of getter material distinct from the portion of getter material permeable to gas such that said other portion of getter material is capable of absorption and/or adsorption of gas through at least the portion of getter material permeable to gas.

The portion of getter material permeable to gas may surround all or some of said other portion of getter material.

The portion of getter material permeable to gas may comprise one or several channels made in or through said portion of getter material permeable to gas. In this case, gas can circulate in all or some of the portion of getter material through these channels.

The portion of getter material permeable to gas may comprise at least one porous material. In this case, the getter material comprises lateral and vertical pores, or porosities, through which gas can circulate in the entire portion of getter material through these pores.

The pores of the porous getter material may for example be open and have dimensions between about a few nanometers and a few hundred nanometers, for example between about 2 nm and 900 nm. The dimensions of the pores of the porous getter material may have an influence on access rate of gas to the getter material.

The thickness of the protective layer may be about 100 nm or more.

The getter structure may also comprise a stack of several portions of getter material permeable to gas and several other portions of getter material, at least one face of each of said other portions of getter material may be placed in contact with at least one of the portions of getter material permeable to gas such that each of said other portions of getter material can do a gas absorption and/or adsorption through said face, through said at least one of the portions of getter material permeable to gas, the protective layer possibly covering said stack.

The protective layer may entirely encapsulate the portion(s) of getter material permeable to gas and, when the getter structure comprises at least one other portion of getter material, the protective layer may entirely encapsulate said other portion(s) of getter material, the local opening possibly forming an access to at least the portion(s) of getter material permeable to gas. When the getter structure comprises said other portion(s) of getter material, the local opening may also form an access to said other portion(s) of getter material, possibly through the permeable portions of getter material.

One embodiment of the invention also relates to a device comprising at least one cavity in which at least one getter structure like that described above is hermetically encapsulated. In such a device, the local opening is advantageously made after encapsulation of the getter structure in the cavity.

The cavity may be formed between a substrate and a cover, the getter structure possibly being fixed to the substrate and/or the cover. Thus the getter structure may be fixed to the substrate, or to the cover, or to both the substrate and the cover.

The device may also comprise at least one microcomponent hermetically encapsulated in the cavity.

It also discloses a process for making a getter structure comprising at least the following steps:
make at least one portion of getter material permeable to gas;
make at least one protective layer hermetic to gas covering the portion of getter material permeable to gas;
make at least one local opening through the hermetic protective layer, forming an access to the portion of getter material permeable to gas.

The local opening may be made by at least one local melting of the protective layer (for example a laser impact located on the protective layer or eutectic melting of the protective layer with a meltable material locally transferred on this layer at the location at which the opening must be made) and/or breaking a part of the getter structure. Thus, the local opening may be made by at least one local melting of the protective layer, or breaking a part of the getter structure, or both at least one local melting of the protective layer and breaking a part of the getter structure.

The portion of getter material permeable to gas may be made by at least one deposit of getter material on a support, the protective layer possibly being deposited on the portion of getter material permeable to gas and on a part of the support.

The process may also comprise the production of a first part of the protective layer in contact with a support before the production of the portion of getter material permeable to gas, the portion of getter material permeable to gas possibly being made later on this first part of the protective layer and possibly also comprising production of a second part of the protective layer covering the portion of getter material permeable to gas and supported on the first part of the protective layer.

The process may also comprise, between the step in which the portion of getter material permeable to gas is made and the step in which the protective layer is made, a step of making at least one other portion of getter material distinct from the portion of getter material permeable to gas and placed in contact with the portion of getter material permeable to gas, such that said other portion of getter material is capable of doing gas absorption and/or adsorption (that is gas absorption, or gas adsorption, or both gas absorption and gas adsorption) through at least the portion of getter material permeable to gas, the protective layer possibly covering said other portion of getter material.

The process may also comprise, before the step in which the portion of getter material permeable to gas is produced, a step of making at least one other portion of getter material distinct from the portion of getter material permeable to gas, the portion of getter material permeable to gas possibly being made on said other portion of getter material so that said other portion of getter material is capable of do gas absorption and/or adsorption (that is gas absorption, or gas adsorption, or both gas absorption and gas adsorption) through at least the portion of getter material permeable to gas, the protective layer possibly covering said portion of getter material permeable to gas.

The portion of material permeable to gas may be made such that it surrounds or projects from all or some of said other portion of getter material.

The process may comprise the production of a stack of several portions of getter material permeable to gas and several other portions of getter material such that at least one face of each of said other portions of getter material is placed in contact with at least one of the portions of getter material permeable to gas, each of said other portions of getter material being capable of gas absorption and/or adsorption (that is gas absorption, or gas adsorption, or both gas absorption and gas adsorption) through said face through said at least one of the portions of getter material permeable to gas, the protective layer possibly covering said stack.

The protective layer may entirely encapsulate the portion(s) of getter material permeable to gas, and when the getter structure comprises at least one other portion of getter material, the protective layer may entirely encapsulate said other portion(s) of getter material, the local opening possibly forming an access to at least the portion(s) of getter material permeable to gas. When the getter structure comprises said other portion(s) of getter material, the local opening may also form an access to said portion(s) of getter material.

Another embodiment of the invention also relates to a process for making a device comprising at least the following steps:
make a getter structure like that described above;
hermetic encapsulation of the getter structure in a cavity;

in which the local opening of the getter structure is made after the hermetic encapsulation of the getter structure in the cavity.

The cavity may be formed by fixing a substrate to a cover, the getter structure possibly being fixed to the substrate and/or the cover.

The process may also comprise production of a microcomponent and hermetic encapsulation of the microcomponent in the cavity.

### BRIEF DESCRIPTION OF THE DRAWINGS

This invention will be better understood after reading the description of example embodiments given purely for guidance and that are in no way limitative with reference to the appended drawings in which:

FIGS. 1A and 1B show steps in a process for making a device in which a process for making a getter structure is used according to a first embodiment;

FIGS. 2A to 2C show getter structures according to other embodiments;

FIG. 3 shows a diagrammatic top view of a porous getter material of a getter structure;

FIG. 4 shows a diagrammatic top view of a getter material comprising channels;

FIGS. 5A to 5C show steps of a process for making a device in which a process for making a getter structure is used, according to a fourth embodiment;

FIGS. 6A to 6C show steps of a process for making a device in which a process for making a getter structure is used, according to a fifth embodiment.

Identical, similar or equivalent parts of the different figures described below are marked with the same numeric references to facilitate comparison between the different figures.

The different parts shown in the figures are not necessarily all at the same scale, to make the figures more easily readable.

The various possibilities (variants and embodiments) must be understood as being not exclusive of each other and may be combined together.

### DETAILED PRESENTATION OF PARTICULAR EMBODIMENTS

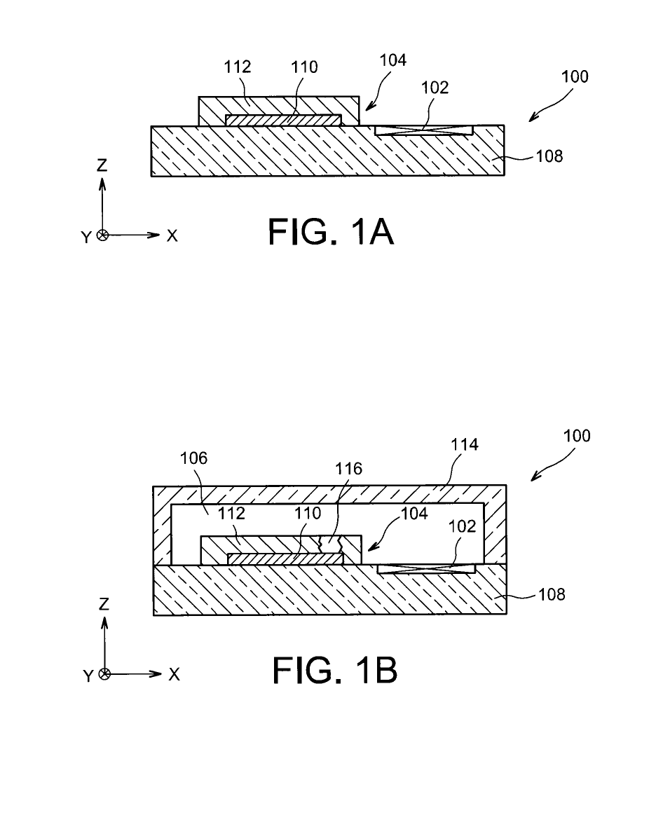

Refer to FIGS. 1A and 1B that show steps in making a device 100 according to a first embodiment comprising a microcomponent 102 intended to be encapsulated with a getter structure 104 in a cavity 106.

The device 100 comprises the microcomponent 102 made on a support, in this case a substrate 108 for example comprising a layer of semiconducting material.

The getter structure 104 is also made on the substrate 108 adjacent to the microcomponent 102.

In FIG. 1A, the getter structure 104 comprises a portion of getter material permeable to gas 110 formed on the substrate 108 and a protective layer 112 hermetic to gas and completely covering the portion of getter material permeable to gas 110. The portion of getter material permeable to gas 110 and the hermetic protective layer 112 are for example formed by successive depositions advantageously made in a single vacuum cycle or under the same atmosphere. A “single vacuum cycle” means that the structure is not exposed to free air. In a single vacuum cycle, it might be possible to bring the structure under a neutral atmosphere particularly for the transfer from one piece of equipment to another, for example from one deposition chamber to another, to avoid saturating the deposited getter material.

The getter material in portion 110 is a non-evaporable getter material, for example titanium and/or zirconium and/or chromium and/or vanadium and/or niobium and/or tantalum and/or any other alloy or material with gas absorption and/or adsorption properties. The portion of getter material permeable to gas 110 may for example be between about 50 nm and 10 μm thick. The portion of getter material permeable to gas 110 may also be made in the form of a thin layer.

The hermetic protective layer 112 for example comprises gold and/or aluminium and for example its thickness may be between 100 nm and several micrometers or several tens of micrometers, the upper limit of this thickness being dependent only on the maximum required size within the device 100. The hermetic protective layer 112 thus protects the portion of getter material permeable to gas 110 during application of steps that might for example damage the getter material and/or deteriorate the gas absorption and/or adsorption properties of the getter material, for example in the case of chemical cleaning by HF solution. This protective layer 112 can also temporarily prevent the getter material 110 from gas pumping (due to the fact that the getter material 110 is not required to do this gas pumping until after it has been placed in the cavity that will be hermetically sealed). In this first embodiment, the hermetic protection of the getter material permeable to gas 110 is also partly provided by the substrate 108 in contact with which the portion of getter material permeable to gas 110 is placed.

The getter material may firstly be deposited in the form of a layer for example by evaporation or by sputtering, on the substrate 108, and then structured (for example by etching) so as to form the portion 110 at the required dimensions, or it may be done directly by a deposit of getter material through a stencil.

As shown in FIG. 1B, the next step is hermetic sealing of a cover 114 on the substrate 108 in order to encapsulate the getter structure 104 and the microcomponent 102 in the same cavity 106. For example, the cover 114 may be composed of glass.

Thus, the getter material of the structure 104 is hermetically protected during hermetic sealing of the cover 114 on the substrate 108 by the protective layer 112. The temperature at which this hermetic sealing of the cover 114 is done can cause thermal activation of the portion of getter material permeable to gas 110. The hermetic protective layer 112 can then prevent the getter material from doing a gas absorption and/or adsorption during this sealing.

When we want to “activate” the gas absorption and/or adsorption function of the getter material 110 once the cover 114 has been sealed to the substrate 108, a local opening 116 is made through the hermetic protective layer 112, for example by laser impact through the cover 114. The cover 114 in this case is transparent (for example it is composed of glass) to the laser used to locally expose the getter material 110 through the opening 116, so that the laser can pass through the cover 114 and make the local opening 116 by laser impact on the material in the hermetic protective layer 112. The opening 116 opens up on the surface of the portion of getter material permeable to gas 110. Therefore, the hermetic protective layer 112 is not completely eliminated when the getter material has performed its gas pumping function by being exposed to the ambient atmosphere.

Although the opening 116 is local, in other words it only exposes part of the portion of getter material permeable to gas 110, the gas absorption and/or adsorption is done by the entire portion of getter material 110 due to the permeability of portion 110 to gas.

The portion of getter material 110 may be made permeable to gas by the fact that the getter material in the portion 110 comprises open pores so that gas can circulate through them. In this case, the portion of getter material 110 comprises within it lateral pores (pores with openings on its side faces) and vertical pores (pores with openings on its front and back faces), these different pores communicating together inside the portion 110. Thus, gas can circulate through the pores in the portion 110.

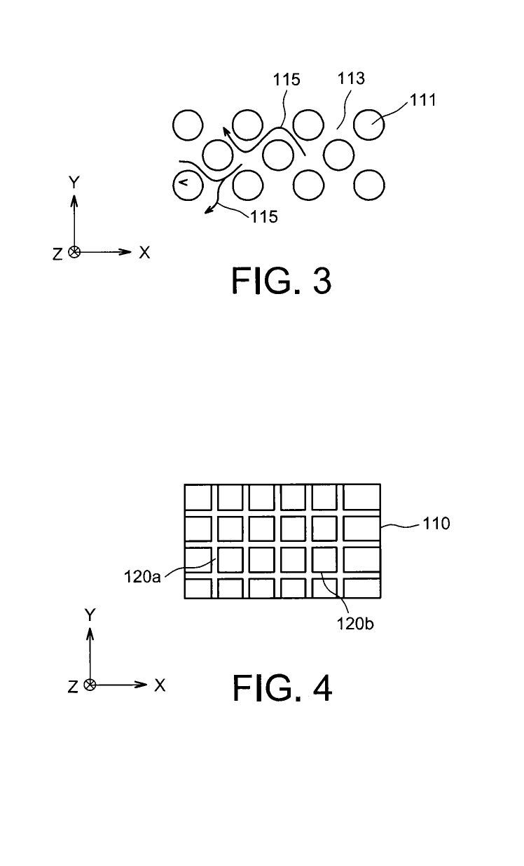

Such a porous getter material comprises vertical and lateral pores formed between the grains of the getter material allowing circulation of a gas within the portion 110. Therefore, it is possible to make an opening 116 with small dimensions. Such a porous getter material may be obtained by a deposition made at a deposition temperature Ts such that the Ts/Tm ratio is less than about 0.3, where Tm is the melting temperature of the getter material and the temperatures Ts and Tm are expressed in degrees Kelvin. When the porous getter material is deposited by evaporation under these deposition conditions, the porous getter material obtained then has a columnar structure comprising inverted cones (the largest part of the cone at the top), dome-shaped in the upper part, these cones being separated by empty spaces. FIG. 3 shows a diagrammatic top view of a porous getter material.

FIG. 3 shows that spaces 113 between the columnar grains 111 of the getter material enable gas circulation within the getter material, this circulation being represented by arrows 115. The book “Materials Science of Thin Films”, Second Edition, Milton Ohring, Academic Press, chapter 9.2.1.2 SZM for Evaporated Films, page 498, describes details of how such porous material can be made.

Permeability of the portion of getter material 110 to gas may also be achieved by structuring the portion of getter material 110 so as to form channels or micro-channels through the portion of getter material through which gas can circulate through the getter material. These channels, for example obtained by the use of photolithography and etching steps, can pass through the entire thickness of the portion of getter material 110 (this thickness may for example be between 1 μm and 10 μm), from a front face of the portion of getter material 110 located on the same side as the local opening 116 as far as a back face of the portion of getter material 110 on the same side as the substrate 108. The channels are made through the portion of getter material 110 before the portion of the getter material is covered by the hermetic protective layer 112.

FIG. 4 shows a diagrammatic top view of the portion of getter material 110 comprising such channels 120. This figure shows that the permeability function is obtained by means of channels 120, for example arranged in the form of a grid composed of vertical channels 120a and horizontal channels 120b perpendicular to each other. Thus, a gas can enter from the front face of the portion of getter material 110 through the parts of the channels 120 located at the opening(s) 116 made through the hermetic protective layer 112 and diffuse throughout the portion of getter material 110 circulating both vertically and laterally through the channels 120. The width of the channels may for example be between about 100 nm and 1 μm. The channels 120 are preferably made such that their aspect ratio (height/width) is greater than or equal to 2.

In the example shown in FIG. 4, the channels 120 open up at the lateral faces of the portion of getter material 110. However in one variant, it is possible that the channels 120 do not open up laterally.

The pattern formed by the channels 120 may be different from the pattern shown in FIG. 4, and does not necessarily form a grid. Thus, the channels 120 may be in the form of a star, or any other pattern.

Several local openings 116 may be made through the hermetic protective layer 112, these openings forming different accesses to the getter material 110. The opening(s) 116 may be in any shape, for example cylindrical and their dimension (for example a diameter in the case of cylindrical shaped openings) in the (X,Y) plane may be between about 1 and 10 μm.

If the portion of getter material 110 and the hermetic protection layer 112 were not made in a single vacuum cycle, the getter material may be thermally activated during its hermetic encapsulation.

This thermal activation can regenerate the getter material's potential pumping capacity. The potential pumping capacity of the getter will preferably be regenerated before a local opening is made in the hermetic protective layer. The result obtained will be a getter material with its entire active potential hermetically encapsulated.

This protective encapsulation by the layer 112 can firstly maintain this potential pumping capacity active until the getter is put into place in the device and the local opening 116 is made in the hermetic protective layer 112 forming an access channel to the getter material. Secondly, encapsulation can also perform a protective role against any aggression occurring during the process that has to be completed before the final product is obtained: for example during chemical cleaning incompatible with the getter material (for example using an HF solution) or during a heat treatment under an atmosphere that can be pumped by the getter, for example under an N₂ atmosphere at a temperature of about 400° C.

Since the getter material is hermetically encapsulated, degassing of the cover can be done at temperatures such that a getter that is not hermetically protected would be activated and would start gas pumping (in the enclosure of the degassing chamber or when returned into free air). Since the getter material is hermetically encapsulated, degassing of the cover and the return into air will not degrade the potential pumping capacity of the getter.

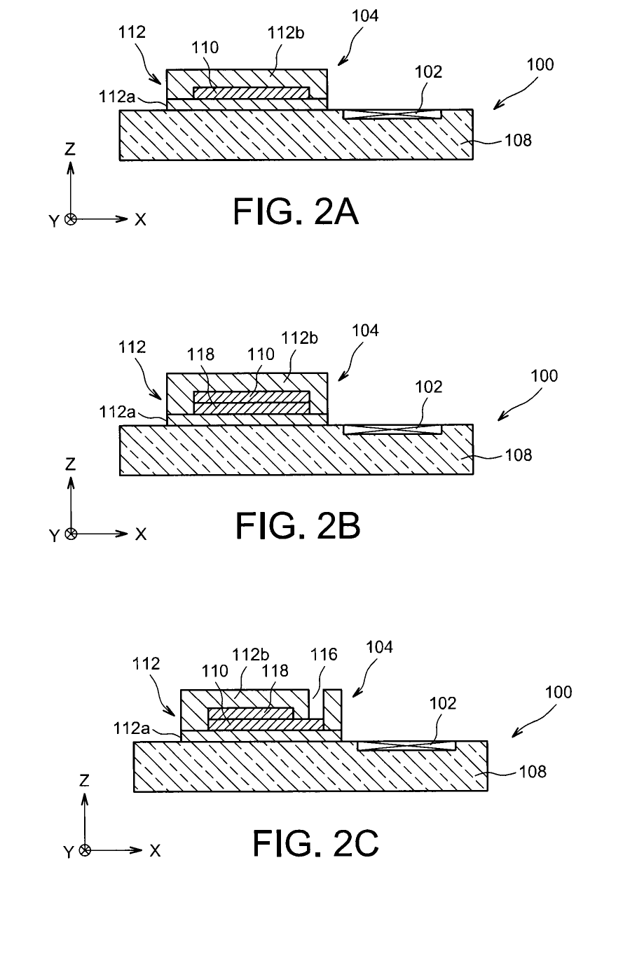

In a second embodiment shown in FIG. 2A, the getter structure 104 may comprise the portion of getter material permeable to gas 110 that is completely surrounded by the hermetic protective layer 112. For example, such a configuration can be obtained firstly by depositing a first part 112a of the hermetic protective layer 112, this first part 112a forming a portion of material (plane in the example described herein) in contact with the substrate 108. The portion of getter material permeable to gas 110 is then deposited on the first part 112a of the hermetic protective layer 112. Channels may be made through the portion of getter material permeable to gas 110.

Finally a second part 112b of the hermetic protective layer 112 is deposited such that this hermetic protective layer 112 completely surrounds and hermetically protects the portion of getter material permeable to gas 110. All these steps will advantageously be made in a single vacuum cycle or under the same atmosphere.

Although not shown, and as previously described with reference to FIG. 1B, the getter structure 104 and the microcomponent 102 are encapsulated within the cavity 106 formed by sealing the cover 114 to the substrate 108. One or several openings 116 are then made through the hermetic protective layer 112. Such a variant is advantageously made when the hermeticity of the substrate 108 is not sufficient to hermetically protect the portion of getter material permeable to gas 110.

FIG. 2B shows a third embodiment. Unlike the second embodiment described above with reference to FIG. 2A, the portion of getter material permeable to gas 110 covers another portion of getter material 118. Therefore, the hermetic protective layer 112 completely surrounds the portion of getter material permeable to gas 110 and the other portion of getter material 118.

The portion of getter material 118 may for example be between about 100 nm and 10 μm thick.

Considering the permeability of the portion of getter material 110, the entire face called the front face of the other portion of getter material 118 located in contact with the portion of getter material permeable to gas 110 can do a gas absorption and/or adsorption through the pores and/or channels passing through the portion of getter material permeable to gas 110, the local opening(s) made through the protective layer 112 opening up onto the portion of getter material permeable to gas 110.

In the example described herein, the getter structure is for example obtained by making the portions of the first part 112a of the hermetic protective layer 112 that are then not covered by the getter material 110, on the face of the substrate 108 on which the microcomponent 102 is placed. On this first part 112a, a deposit of the getter material intended to form the portion 118 is then made and structured (for example by etching) so as to only keep the portion of getter material 118 the dimensions of which correspond to the required dimensions, in this case equivalent to the dimensions of the portion of getter material permeable to gas 110. The portion of getter material permeable to gas 110 is then made on the portion of getter material 118, the assembly then being encapsulated by the second part 112b of the hermetic protective layer 112. As a variant, the portion of getter material 118 may be made with a single step by depositing the getter material through a stencil, thus directly forming the portion of getter material 118 at the required dimensions. In one advantageous embodiment, the portions of getter material 118 and 110 may both be made by two successive deposits through the same stencil, possibly during a single vacuum cycle, in other words without returning to air between these two deposits. The second part 112b of the hermetic protective layer 112 may also be made by a deposit applied after the portion of getter material 110 has been made during a single vacuum cycle.

According to another variant shown in FIG. 2C, the portions of getter material 118 and 110 are inverted in the stack. As described above with reference to FIG. 1B, the getter structure 104 (formed by the portion of getter material permeable to gas 110, the portion of getter material 118 and the hermetic protective layer 112 in sequence) and the microcomponent 102 may be encapsulated within the cavity 106 formed by sealing the cover 114 to the substrate 108. One or several openings 116 are then made through the hermetic protective layer 112, for example by laser impact. In this embodiment, the portion of getter material 110 permeable to gas is placed under the portion of getter material 118 and therefore provides access to the back face of the portion 118. The portion 110 comprises dimensions larger than the dimensions of the portion 118 so that the opening 116 opens up directly on this portion 110.

The getter material of the portion 110 therefore does a gas absorption and/or adsorption through the opening(s) 116, and the getter material in the other portion 118 does a gas absorption and/or adsorption through the opening(s) 116 and through the pores and/or the channels of the getter portion 110 permeable to gas. The advantage of such a configuration is that the entire surface of the getter material 118 (back face in the case of FIG. 2C) on the side of the portion of getter material permeable to gas 110 can do a gas absorption and/or adsorption, even if a single small opening 116 is made through the hermetic protective layer 112. Thus, the result obtained is a getter structure comprising at least two different getter materials that can have different gas absorption and/or adsorption properties.

As a variant, the portion of getter material permeable to gas 110 may partly or completely surround the other portion of getter material 118, and can therefore cover the side faces and/or the back face (on the side of the substrate 108) of the portion of getter material 118.

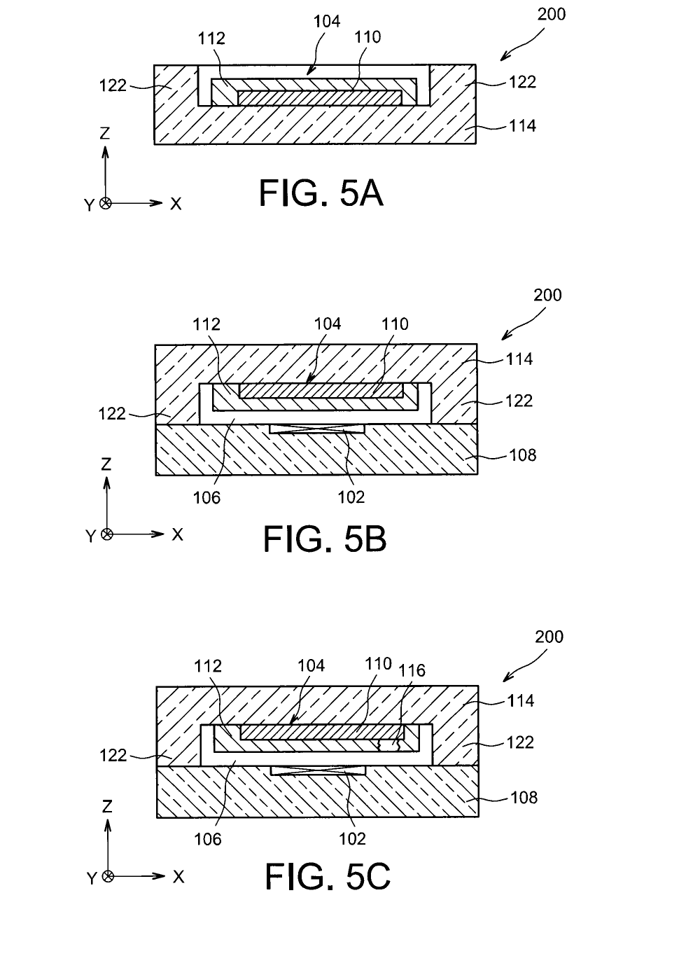

FIG. 5A shows a device 200 according to a fourth embodiment comprising the getter structure 104 similar to that described above with reference to FIG. 1. The getter structure 104 comprises the portion of getter material permeable to gas 110 covered by the hermetic protective layer 112. In this fourth embodiment, the getter structure 104 is made on the cover 114 that acts as a support for the portion of getter material permeable to gas 110 and the protective layer 112. The cover 114 comprises side portions 122 intended to form sidewalls of the cavity 106 in which the getter structure 104 will be encapsulated with the microcomponent 102.

The cover 114 is then assembled to the substrate 108 on which the microcomponent 102 is made, for example of the MEMS and/or NEMS type, thus forming the device 200 (FIG. 5B). Therefore the microcomponent 102 is encapsulated in the cavity 106 formed between the cover 114 and the substrate 108 and in which the getter structure 104 is also encapsulated.

The sidewalls of the cavity 106 correspond to the side portions 122 of the cover 114. The side portions 122 are assembled to the substrate 108 by a seal that hermetically closes the cavity 106, obtained for example by molecular bonding or any other appropriate sealing technique such as an anodic or eutectic seal.

Therefore the different technological steps done later on the device 200 have no impact on the getter material permeable to gas 110, provided that it is protected by the hermetic protective layer 112.

Furthermore, the pumping capacities of the getter material permeable to gas 110 are preserved as long as the getter material is hermetically confined between the protective layer 112 and the cover 114.

When it is required to “activate” the gas absorption/adsorption function of the getter material, the opening 116 is made through the hermetic protective layer 112 so as to form an access to the portion of getter material permeable to gas 110 (FIG. 5C). For example, this opening 116 can be made by laser impact through the substrate 108 (for example based on a material transparent to the laser used).

If this laser impact creates any slag (solid waste), then this opening 116 may be made in a portion of the protective layer 112 at a distance from the microcomponent 102 to reduce or eliminate pollution of this slag that could potentially modify operation of the microcomponent 102.

Due to this opening 116, the getter material permeable to gas 110 can perform its gas absorption and/or adsorption function through the opening 116. For example, it is thus possible to make an environment under low pressure in the cavity 106 around the microcomponent 102.

In one variant embodiment of the device 200, the getter structure 104 may correspond to one of the structures previously described with reference to

FIGS. 2A and 2B, in other words it may comprise another portion of getter material 118 and/or be completely surrounded by the hermetic protective layer 112.

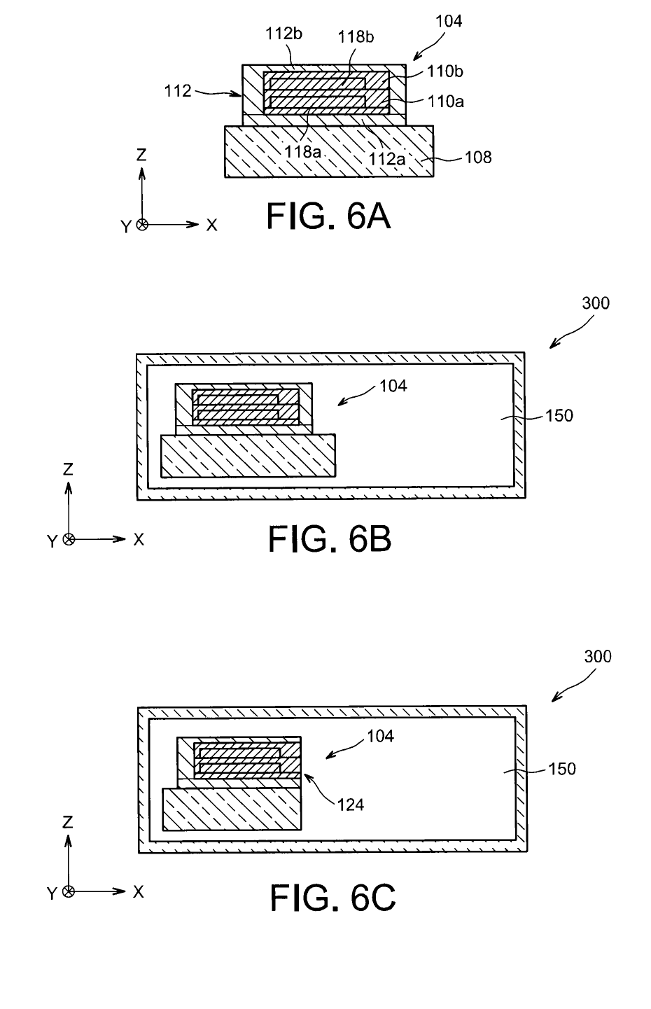

FIGS. 6A to 6C show steps in making a device 300 according to a fifth embodiment.

As shown in FIG. 6A, the getter structure 104 in this case comprises a stack of several portions of getter material (two in the example in FIG. 6) 118a and 118b placed on part of the substrate 108. In this case, the portions of getter material 118a, 118b are completely surrounded by portions of getter material permeable to gas 110a, 110b. The entire assembly of this stack is protected by the hermetic protective layer 112 that completely surrounds the portions of getter material permeable to gas 110a, 110b, and therefore entirely covers the other portions of getter material 118a, 118b. In this fifth embodiment, all faces of other portions of getter material 118a, 118b are in contact with the getter material permeable to gas in portions 110a, 110b. The result obtained is thus a getter structure 104 that can be used autonomously, and possibly for example could be arranged in a cavity 150 of a device 300, for example a screen tube (see FIG. 6B). The permeability of portions of getter material 110a, 110b to gas is obtained by channels formed through the portions 110a, 110b and/or due to the fact that the getter material in portions 110a, 110b is porous.

A local opening in the getter structure 104 is made to activate the gas pumping function of the getter structure 104, so as to expose some of the portions of getter material permeable to gas 110a, 110b (FIG. 6C). This opening may for example be obtained by breaking part of the getter structure 104, for example by applying a shock on the getter structure 104 in contact with a wall of the cavity 150 or by laser firing. The result obtained is thus a local opening 214 formed through the hermetic protective layer 112 forming an access to the portions of getter material permeable to gas 110a, 110b and to other portions of getter material 118a, 118b through pores and/or channels of the portions of getter material permeable to gas 110a, 110b. Production of the local opening 124 in the getter structure 104 can be facilitated by firstly making a mechanical starting point within the getter structure 104. This opening 124 may be made by keeping the portions of getter material 118a, 118b intact.

Thus, the portions of getter material permeable to gas 110a, 110b and the other portions of getter material 118a, 118b can do gas absorption and/or adsorption from all their faces (front, back, and side faces), through the opening 124 made through the protective layer 112 and that opens onto the portions of getter material permeable to gas 110a, 110b.

The getter structure 104 shown in FIG. 6A may be obtained by firstly making a first part 112a of the hermetic protective layer 112, for example by deposition, this part forming a flat portion of a layer placed in contact with the substrate 108. A first part (also in the form of a flat portion) of the first portion of getter material permeable to gas 110a is then formed on the first part 112a of the hermetic protective layer 112. The first other portion of getter material 118a is then deposited on the first part of the first portion of getter material permeable to gas 110a. A second part of the first portion of getter material permeable to gas 110a is then deposited on the first other portion of getter material 118a such that the first other portion of getter material 118a is completely surrounded by the first portion of getter material permeable to gas 110a. The second other portion of getter material 118b is then deposited on the first portion of getter material permeable to gas 110a, for example using the same stencil as was used for deposition of the first other portion of getter material 118a. The second portion of getter material permeable to gas 110b is then deposited and completely covers the second other portion of getter material 118b. Finally, a second part 112b of the hermetic protective layer 112 is then deposited such that this hermetic protective layer 112 surrounds and hermetically protects the portions of getter material 110a, 110b, 118a and 118b. All these steps will advantageously be made in a single vacuum cycle.

In all embodiments, the getter material is usually made active after its deposition (when the different depositions are not made during a single vacuum cycle) and for example after its encapsulation in the hermetic protective layer 112, through a thermal activation step. For example, in the case of a getter material composed of titanium, such a thermal activation may be done at a temperature for example between about 350° C. and 450° C.

In all the embodiments described above, the portion(s) of getter material is (are) plane due to the fact that the different supports on which the portion(s) of getter material is (are) made have an approximately flat surface. However, it would be possible that the portion of getter material is not flat and that it comprises relief (recesses and/or bumps or projections).

In all the embodiments described above, it is possible that several portions of getter material permeable to gas are surrounded by or covered by the hermetic protective layer. In this case, the portions of getter material permeable to gas may be arranged adjacent to each other and/or on top of each other, and possibly be at intervals from each other.

1. A process for making a device comprising at least the following steps:
produce a getter structure comprising at least one portion of getter material permeable to gas covered by at least one protective layer hermetic to gas;
hermetic encapsulation of the getter structure in a cavity;
production of at least one local opening passing through the protective layer and forming an access to the portion of getter material permeable to gas.

2. The process according to claim 1, in which the portion of getter material permeable to gas comprises one or several channels made in said portion of getter material permeable to gas.

3. The process according to claim 1, in which the portion of getter material permeable to gas comprises at least one porous material.

4. The process according to claim 1, in which the thickness of the protective layer is about 100 nm or more.

5. The process according to claim 1, in which the cavity is formed between a substrate and a cover, the getter structure being fixed to the substrate, or to the cover, or to both the substrate and the cover.

6. The process according to claim 1, also comprising at least one microcomponent hermetically encapsulated in the cavity.

7. The process according to claim 1, in which the local opening is made by at least one local melting of the protective layer, or breaking a part of the getter structure, or both at least one local melting of the protective layer and breaking a part of the getter structure.

8. The process according to claim 1, in which the portion of getter material permeable to gas is made by at least one deposit of getter material on a support, the protective layer being deposited on the portion of getter material permeable to gas and on a part of the support.

9. The process according to claim 1, also comprising the production of a first part of the protective layer in contact with a support before the production of the portion of getter material permeable to gas, the portion of getter material permeable to gas being made later on this first part of the protective layer, and also comprising production of a second part of the protective layer covering the portion of getter material permeable to gas and supported on the first part of the protective layer.

10. The process according to claim 1, also comprising, between a step in which the portion of getter material permeable to gas is made and a step in which the protective layer is made, a step of making at least one other portion of getter material distinct from the portion of getter material permeable to gas and placed in contact with the portion of getter material permeable to gas such that said other portion of getter material is capable of doing gas absorption, or gas adsorption, or both gas absorption and gas adsorption, through at least the portion of getter material permeable to gas, the protective layer covering said other portion of getter material.

11. The process according to claim 1, also comprising, before a step in which the portion of getter material permeable to gas is produced, a step of making at least one other portion of getter material distinct from the portion of getter material permeable to gas, the portion of getter material permeable to gas being made on said other portion of getter material such that said other portion of getter material is capable to do gas absorption, or gas adsorption, or both gas absorption and gas adsorption, through at least the portion of getter material permeable to gas, the protective layer covering said portion of getter material permeable to gas.

12. The process according to claim 10, in which the portion of material permeable to gas is made such that it surrounds all or some of said other portion of getter material.

13. The process according to claim 1, comprising the production of a stack of several portions of getter material permeable to gas and several other portions of getter material such that at least one face of each of said other portions of getter material is placed in contact with at least one of the portions of getter material permeable to gas, each of said other portions of getter material being capable of gas absorption, or gas adsorption, or both gas absorption and gas adsorption, through said face through said at least one of the portions of getter material permeable to gas, the protective layer covering said stack.

14. The process according to claim 1, in which the protective layer entirely encapsulates the portion(s) of getter material permeable to gas and when the getter structure comprises at least one other portion of getter material, the protective layer entirely encapsulates said other portion(s) of getter material, the local opening forming an access to at least the portion(s) of getter material permeable to gas.

15. Process according to claim 1, also comprising the production of a microcomponent and an hermetic encapsulation of the microcomponent in the cavity.
